(19) United States
(12) Patent Application Publication
(10) Pub. No.: US 2015/0278868 A1
(43) Pub. Date: Oct. 1, 2015

(54) SYSTEMS AND METHODS FOR IDENTIFYING AND EXPOSING CONTENT ELEMENT DENSITY AND CONGESTION

(71) Applicant: Google Inc., Mountain View, CA (US)

(72) Inventors: Timothy Wong O'Connor, Moraga, CA (US); Fei Qi, Sunnyvale, CA (US)

(73) Assignee: Google Inc., Mountain View, CA (US)

(21) Appl. No.: 14/090,108

(22) Filed: Nov. 26, 2013

(51) Int. Cl. G06Q 30/02; G06F 17/30

(52) U.S. Cl. CPC G06Q 30/0263; G06F 17/30595

(57) ABSTRACT

Systems and methods for identifying and exposing content element density and congestion are provided. A descripted method includes injecting a measurement object into published content. The measurement object is configured to automatically measure a clutter attribute of the published content and to generate a clutter metric for the published content based on the measured clutter attribute. The method further includes receiving the clutter metric from the injected measurement object, storing the clutter metric in a clutter statistics database, receiving a notification of an available impression for presenting a third-party content item in conjunction with the published content, exposing the available impression to one or more third-party content providers, and providing the one or more third-party content providers with a quality score for the published content. The quality score is based at least partially on the clutter metric for the published content.

### BACKGROUND

The Internet provides access to a wide variety of content. A content distribution system may allow a third-party content provider to automatically provide its content in conjunction with that of a first-party resource. For example, the content distribution system may allow an advertiser to bid on an opportunity to present an advertisement on a particular webpage. Content selection and distribution can be automated by a programmatic Internet advertising system.

In certain programmatic Internet advertising systems, third-party content providers (e.g., advertisers) may be notified of an available impression (i.e., an opportunity to place an advertisement on a webpage) and provided with limited information for use in determining whether to bid on the impression. For example, third-party content providers may be provided with demographic information about the user to which the advertisement will be displayed, user location, user interests, and some basic information about the webpage on which the advertisement will be displayed (e.g., webpage URL, webpage topic, etc.).

### SUMMARY

One implementation of the present disclosure is a method for identifying and exposing content element density and congestion. The method includes injecting a measurement object into published content. The measurement object is configured to automatically measure a clutter attribute of the published content and to generate a clutter metric for the published content based on the measured clutter attribute. The method further includes receiving the clutter metric from the injected measurement object, storing the clutter metric in a clutter statistics database, receiving a notification of an available impression for presenting a third-party content item in conjunction with the published content, exposing the available impression to one or more third-party content providers, and providing the one or more third-party content providers with a quality score for the published content. The quality score is based at least partially on the clutter metric for the published content.

In some implementations, the method further includes auctioning the available impression to the one or more third-party content providers, selecting a winning bid received from the one or more third-party content providers as a result of the auction, and serving a third-party content for presentation in conjunction with the published content, the third-party content item corresponding to the winning bid. In some implementations, the method further includes automatically adjusting the winning bid based on the clutter metric.

In some implementations, the measurement object is injected into the published content prior to the published content fully loading. The measurement object may be configured to wait until the published content is fully loaded before measuring the clutter attribute of the published content.

In some implementations, the measurement object is injected into the published content in response to receiving a previous notification of an available impression for presenting a third-party content item in conjunction with the published content. In some implementations, the method further includes serving a previous third-party content item for presentation in conjunction with the published content in response to the previous notification of an available impression. Serving the previous third-party content item may occur prior to the measurement object measuring the clutter attribute.

In some implementations, the method further includes receiving a previous notification of an available impression for presenting a third-party content item in conjunction with the published content and serving a previous third-party content item for presentation in conjunction with the published content in response to the previous notification of an available impression. Injecting the measurement object into the published content may occur concurrently with serving the previous third-party content item. The clutter metric generated by the injected measurement object may be stored in the clutter statistics database for use in serving a next third-party content item, subsequent to the previous third-party content item, for presentation in conjunction with the published content.

In some implementations, the clutter attribute of the published content includes at least one of: a size of an element on the published content for displaying third-party content items relative to other visual elements on the published content, a distance between the element for displaying third-party content items and an adjacent visual element of the published content, a number of visual elements on the published content, and a density of visual elements on the published content.

In some implementations, wherein generating the clutter metric includes parsing a document object model for the published content. In some implementations, the measurement object includes computer-executable code injected into preexisting code of the published content.

In some implementations, providing the one or more third-party content providers with a quality score for the published content includes at least one of: providing the third-party content providers with the clutter metric and providing the third-party content providers with an aggregate quality score for the published content. The aggregate quality score may be based on the clutter metric and one or more other factors.

In some implementations, the method further includes determining a performance metric for a third-party content item. The performance metric may be a function of the clutter metric. The method may further include determining a pricing value for the third-party content item based on the performance metric and determining a target bid for the available impression based on the pricing value of the third-party content item.

Another implementation of the present disclosure is a system for identifying and exposing content element density and congestion. The system includes a processing system configured to inject a measurement object into published content. The measurement object is configured to automatically measure a clutter attribute of the published content and to generate a clutter metric for the published content based on the measured clutter attribute. The processing system is further configured to receive the clutter metric from the injected measurement object, store the clutter metric in a clutter statistics database, receive a notification of an available impression for presenting a third-party content item in conjunction with the published content, expose the available impression to one or more third-party content providers, and provide the one or more third-party content providers with a quality score for the published content. The quality score is based at least partially on the clutter metric for the published content.

In some implementations, the processing system is configured to auction the available impression to the one or more third-party content providers, select a winning bid received from the one or more third-party content providers as a result of the auction, and serve a third-party content for presentation in conjunction with the published content, the third-party content item corresponding to the winning bid. In some implementations, the processing system is configured to automatically adjust the winning bid based on the clutter metric.

In some implementations, the measurement object is injected into the published content prior to the published content fully loading. The measurement object may be configured to wait until the published content is fully loaded before measuring the clutter attribute of the published content.

In some implementations, the processing system is configured to receive a previous notification of an available impression for presenting a third-party content item in conjunction with the published content and serve a previous third-party content item for presentation in conjunction with the published content in response to the previous notification of an available impression. Injecting the measurement object into the published content may occur concurrently with serving the previous third-party content item. The clutter metric generated by the injected measurement object may be stored in the clutter statistics database for use in serving a next third-party content item, subsequent to the previous third-party content item, for presentation in conjunction with the published content.

In some implementations, the clutter attribute of the published content includes at least one of: a size of an element on the published content for displaying third-party content items relative to other visual elements on the published content, a distance between the element for displaying third-party content items and an adjacent visual element of the published content, a number of visual elements on the published content, and a density of visual elements on the published content.

In some implementations, generating the clutter metric includes parsing a document object model for the published content. In some implementations, the measurement object includes computer-executable code injected into preexisting code of the published content.

In some implementations, providing the one or more third-party content providers with a quality score for the published content includes at least one of providing the third-party content providers with the clutter metric, and providing the third-party content providers with an aggregate quality score for the published content. The aggregate quality score may be based on the clutter metric and one or more other factors.

Another implementation of the present disclosure is one or more computer-readable media containing instructions for identifying and exposing content element density and congestion, the instructions being executable by one or more processors to cause the one or more processors to perform operations including injecting a measurement object into published content. The measurement object is configured to automatically measure a clutter attribute of the published content and to generate a clutter metric for the published content based on the measured clutter attribute. The operations further include receiving the clutter metric from the injected measurement object, storing the clutter metric in a clutter statistics database, receiving a notification of an available impression for presenting a third-party content item in conjunction with the published content, exposing the available impression to one or more third-party content providers, and providing the one or more third-party content providers with a quality score for the published content. The quality score is based at least partially on the clutter metric for the published content.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a schematic diagram of an example of a computing system including resources, content providers, user devices, data storage devices, a content server, and a clutter assessment system, according to a described implementation.

FIG. 2 is a timing diagram illustrating an example of a concurrent but asynchronous process for identifying and exposing content element density and congestion, showing the interactions between a first-party resource, a real-time-bidding (RTB) exchange, and third-party content providers, according to a described implementation.

FIG. 3 is a block diagram illustrating the example RTB exchange of FIG. 2 in greater detail, according to a described implementation.

FIG. 4 is a flowchart of an example of a process for identifying and exposing content element density and congestion, according to a described implementation.

FIG. 5 is a drawing of an example of a content element with a padding, border, and margin around the content element, according to a described implementation.

FIG. 6 is a drawing of an example of a first-party resource illustrating the distances between the centroids of a third-party content element and other content elements, according to a described implementation.

### DETAILED DESCRIPTION

Referring generally to the FIGURES, systems and methods for identifying and exposing content element density and congestion are shown, according to a described implementation. The systems and methods described herein may be used to automatically measure a clutter attribute of a first-party resource (e.g., a publisher's webpage) and generate a clutter metric for the resource based on the clutter attribute. Clutter attributes may include, for example, the size of a content slot in which the third-party content item is displayed relative to other content elements visible on the resource, the distance between the third-party content slot and other visual content elements, the number and/or density of visual content elements in proximity to the third-party content slot, and/or other visual attributes of the resource.

A first-party resource may include a variety of content elements designed to capture the attention of a user (e.g., headlines, buttons, text snippets, logos, advertisements, etc.). Publishers of premium resource content may desire a consistent design that errs toward minimalism. As such, the clutter metric for a first-party resource may be a relevant signal of the quality of the resource. Additionally, the clutter metric may be relevant to effectiveness of third-party content presented concurrently with the first-party resource.

The systems and methods described herein may automatically measure one or more clutter attributes of a resource using an asynchronous but concurrent measurement process. For example, a content distribution system (e.g., a content server, a programmatic buying/selling system, a real-time bidding system, etc.) may inject a measurement object into the content of a first-party resource while the resource is loading. In some implementations, the content distribution system injects the measurement object into the first-party resource along with a third-party content item (e.g., an advertisement) when the resource is viewed by a user. The measurement object may include, for example, multiple lines of computer-executable code (e.g., JavaScript® code) injected into the code of a webpage. The measurement object may be configured to wait until the resource has finished loading before measuring the one or more clutter attributes.

When the resource has fully loaded (e.g., on a user device, in a web browser, etc.), the measurement object may perform an assessment of the resource's clutter by measuring the one or more clutter attributes. In some implementations, the measurement object assesses the resource's clutter by parsing and analyzing a document object model (DOM) for the resource. For example, the measurement object may traverse the DOM to determine a number of visible content elements, a density of content elements (e.g., number of content elements per visible area, a distance between a third-party content slot element and other elements, and/or other attributes of the resource. The measurement object may use the one or more clutter attributes of the resource to generate a clutter metric for the resource and report the clutter metric back to the content distribution system.

The content distribution system may store the clutter metric in a clutter statistics database. The next time an impression is available for the resource (e.g., the next time a third-party content item is requested for the resource, the next time the resource is loaded or viewed by a user, etc.), the content distribution system may retrieve the clutter metric from the clutter statistics database. The clutter metric may be provided to one or more third-party content providers for use in bidding on the available impression. In various implementations, the clutter metric may be provided to the third-party content providers as part of a combined quality signal for the resource (e.g., combined with other factors relevant to bidding on the available impression) or as a separate signal (e.g., separate or independent from the other factors).

The systems and methods of the present disclosure can measure clutter in a separate concurrent but asynchronous process and immediately expose previously-generated clutter statistics to the third-party content provider. For example, each time a third-party content item is served, the measurement object may be injected into the resource along with the third-party content item. When the resource has finished loading, the measurement object measures the resource's clutter factors and reports clutter metrics back to the content distribution system. The clutter metrics are stored in the clutter statistics database and used for bidding on subsequent impressions for the same resource. This allows the clutter metrics to accurately represent the content element density and congestion of the fully loaded resource. It may also allow the available impression to be served before the resource has fully loaded using previously-generated clutter statistics.

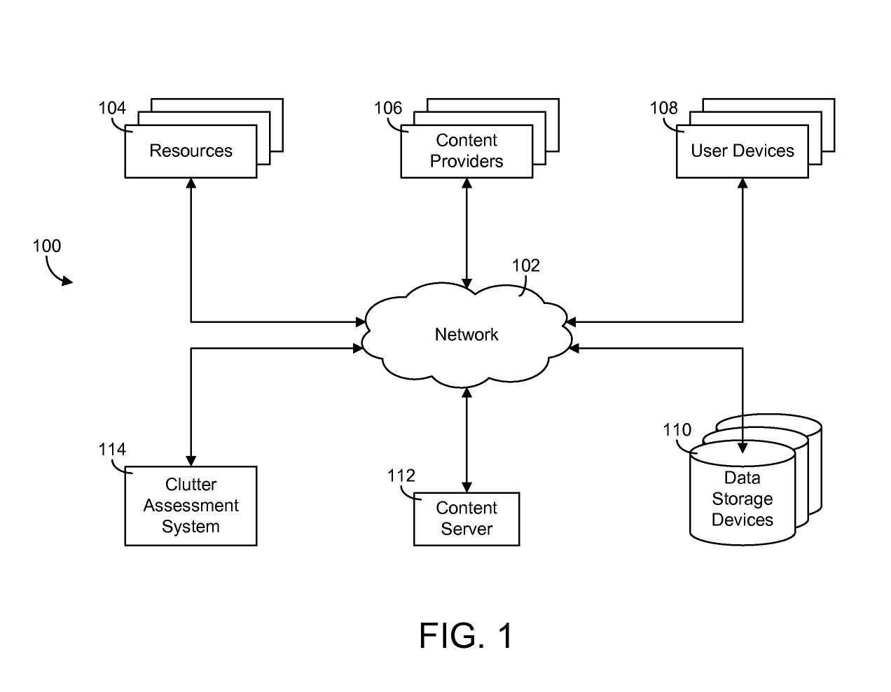

Referring now to FIG. 1, a block diagram of a computing system 100 is shown, according to a described implementation. In brief overview, computing system 100 is shown to include a network 102, resources 104, content providers 106, user devices 108, data storage devices 110, a content server 112, and a clutter assessment system 114. It should be noted that although the various components of computing system 100 are shown and described separately with reference to FIG. 1, in some implementations, one or more components of computing system 100 may be combined into a single component. For example, content server 112 and clutter assessment system 114 may be combined into a single server or server system. As another example, data storage devices 110 may be combined with content server 112, clutter assessment system 114, or content providers 106.

Computing system 100 may facilitate communication between resources 104, content providers 106, and user devices 108. For example, user devices 108 may request and receive first-party resource content (e.g., web pages, documents, etc.) from resources 104 via network 102. In some implementations, resources 104 include content item slots for presenting third-party content items from content providers 106. When resource content is viewed by user devices 108, third-party content items from content providers 106 may be delivered and presented in the content slots of resources 104.

Computing system 100 may also facilitate communication between resources 104, content providers 106, content server 112, and clutter assessment system 114. For example, content server 112 may receive a notification of an available impression from resources 104 when resource content is loaded or viewed by user devices 108. Content server 112 may expose the available impression to content providers 106 and allow content providers 106 the opportunity to bid on the available impression. Content server 112 may select a third-party content item for presentation in a content slot of resources 104 based on the bids received from content providers 106. Content server 112 may interact with clutter assessment system 114 to expose a clutter metric for resources 104 to content providers 106 for use in bidding on the available impression.

Still referring to FIG. 1, computing system 100 is shown to include a network 102. Network 102 may be a local area network (LAN), a wide area network (WAN), a cellular network, a satellite network, a radio network, the Internet, or any other type of data network or combination thereof. Network 102 may include any number of computing devices (e.g., computers, servers, routers, network switches, etc.) configured to transmit, receive, or relay data. Network 102 may further include any number of hardwired and/or wireless connections. For example, user devices 108 may communicate wirelessly (e.g., via WiFi, cellular, radio, etc.) with a transceiver that is hardwired (e.g., via a fiber optic cable, a CAT5 cable, etc.) to a computing device of network 102.

Still referring to FIG. 1, computing system 100 is shown to include resources 104. Resources 104 may include any type of information or data structure that can be provided over network 102. In some implementations, resources 104 may be identified by a resource address associated with each resource (e.g., a uniform resource locator (URL)). Resources 104 may include web pages (e.g., HTML web pages, PHP web pages, etc.), word processing documents, portable document format (PDF) documents, images, video, programming elements, interactive content, streaming video/audio sources, or other types of electronic information. Resources 104 may include content (e.g., words, phrases, images, sounds, etc.) having embedded information (e.g., meta-information embedded in hyperlinks) and/or embedded instructions. Embedded instructions may include computer-readable instructions (e.g., software code, JavaScript®, ECMAScript®, etc.) which are executed by user devices 108 (e.g., by a web browser running on user devices 108).

Resources 104 may include a variety of content elements. For example, content elements may include, textual content elements (e.g., text boxes, paragraph text, text snippets, etc.), image content elements (e.g., pictures, graphics, etc.), video content elements (e.g., streaming video, moving graphics, etc.), hyperlink content elements (e.g., links to webpages, links to other resources, etc.), or any other type of content element that is visible when resources 104 are viewed and/or loaded by user devices 108. Content elements can be arranged in close proximity to each other (i.e., a high content element density) or more sparsely distributed (i.e., a low content element density). Content elements can have various sizes, positions, orientations, or other attributes defining how content elements are displayed on resources 104.

In some implementations, resources 104 may be represented by a document object model. The document object model may be a hierarchical model of resources 104. The document object model may include image information (e.g., image URLs, display positions, display sizes, alt text, etc.), font information (e.g., font names, sizes, effects, etc.), color information (e.g., RGB color values, hexadecimal color codes, etc.), text information, or other information affecting the visual appearance of resources 104 when resources 104 are fully loaded.

In some implementations, resources 104 may include content slots for presenting third-party content items. For example, resources 104 may include one or more inline frame elements (e.g., HTML “iframe” elements, <iframe> . . . </iframe>) for presenting third-party content items from content providers 106. An inline frame can be the “target” frame for links defined by other elements and can be selected by user agents (e.g., user devices 108, a web browser running on user devices 108, etc.) as the focus for printing, viewing its source, or other forms of user interaction. The content slots may cause user devices 108 to request third-party content items in response to viewing first-party resource content from resources 104.

Still referring to FIG. 1, computing system 100 is shown to include content providers 106. Content providers 106 may include one or more electronic devices representing advertisers, business owners, advertising agencies, or other entities capable of generating third-party content to be presented along with first-party content from resources 104. In some implementations, content providers 106 produce third-party content items (e.g., an ad creative) for presentation to user devices 108. In other implementations, content providers 106 may submit a request to have third-party content items automatically generated. The third-party content items may be stored in one or more data storage devices local to content providers 106, within content server 112, or in data storage devices 110.

In some implementations, the third-party content items may be advertisements. The advertisements may be display advertisements such as image advertisements, animated advertisements, video advertisements, text-based advertisements, or any combination thereof. In other implementations, the third-party content items may include other types of content which serve various non-advertising purposes. The third-party content items may be displayed in a content slot of resources 104 and presented (e.g., alongside other resource content) to user devices 108.

In some implementations, content providers 106 may submit campaign parameters to content server 112. The campaign parameters may be used to control the distribution of third-party content items to user devices 108. The campaign parameters may include keywords associated with the third-party content items, bids corresponding to the keywords, a content distribution budget, geographic limiters, or other criteria used by content server 112 to determine when a third-party content item may be presented to user devices 108.

Content providers 106 may access content server 112 to monitor the performance of the third-party content items distributed according to the established campaign parameters. For example, content providers 106 may access content server 112 to review one or more behavior metrics associated with a third-party content item or set of third-party content items. The behavior metrics may describe the interactions between user devices 108 with respect to a distributed third-party content item or set of third-party content items (e.g., number of impressions, number of clicks, number of conversions, an amount spent, etc.). The behavior metrics may be based on user actions logged and processed by an accounting system or log file processing system.

Still referring to FIG. 1, computing system 100 is shown to include user devices 108. User devices 108 may include any number and/or type of user-operable electronic devices. For example, user devices 108 may include desktop computers, laptop computers, smartphones, tablets, mobile communication devices, remote workstations, client terminals, entertainment consoles, or any other devices capable of interacting with the other components of computing system 100 (e.g., via a communications interface). User devices 108 may be capable of receiving resource content from resources 104 and/or third-party content items from content providers 106 or content server 112. User devices 108 may include mobile devices or non-mobile devices.

In some implementations, user devices 108 include an application (e.g., a web browser, a resource renderer, etc.) for converting electronic content into a user-comprehensible format (e.g., visual, aural, graphical, etc.). User devices 108 may include a user interface element (e.g., an electronic display, a speaker, a keyboard, a mouse, a microphone, a printer, etc.) for presenting content to a user, receiving user input, or facilitating user interaction with electronic content (e.g., clicking on a content item, hovering over a content item, etc.). User devices 108 may function as a user agent for allowing a user to view HTML encoded content.

User devices 108 may include a processor capable of processing embedded information (e.g., meta information embedded in hyperlinks, etc.) and executing embedded instructions. Embedded instructions may include computer-readable instructions (e.g., software code, JavaScript®, ECMAScript®, etc.) associated with a content slot within which a third-party content item is presented. For example, when user devices 108 load resource content from resources 104, user devices 108 may also load a measurement object injected into the resource content (e.g., by content server 112, by clutter assessment system 114, etc.). The measurement object may include multiple lines of JavaScript® code. User devices 108 may run the measurement object to measure one or more clutter attributes of the resource content. In some implementations, running the injected measurement object generates clutter metrics based on the one or more measured clutter attributes and reports the clutter metrics to content server 112 and/or clutter assessment system 114.

In some implementations, user devices 108 are capable of detecting an interaction with a distributed content item. An interaction with a content item may include displaying the content item, hovering over the content item, clicking on the content item, viewing source information for the content item, or any other type of interaction between user devices 108 and a content item. Interaction with a content item does not require explicit action by a user with respect to a particular content item. In some implementations, an impression (e.g., displaying or presenting the content item) may qualify as an interaction. The criteria for defining which user actions (e.g., active or passive) qualify as an interaction may be determined on an individual basis (e.g., for each content item), by content providers 106, or by content server 112.

User devices 108 may generate a variety of user actions. For example, user devices 108 may generate a user action in response to a detected interaction with a content item. The user action may include a plurality of attributes including a content identifier (e.g., a content ID or signature element), a device identifier, a referring URL identifier, a timestamp, or any other attributes describing the interaction. User devices 108 may generate user actions when particular actions are performed by a user device (e.g., resource views, online purchases, search queries submitted, etc.). The user actions generated by user devices 108 may be communicated to content server 112 or a separate accounting system.

For situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated (e.g., by content server 112) in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, a user may have control over how information is collected (e.g., by an application, by user devices 108, etc.) and used by content server 112.

Still referring to FIG. 1, computing system 100 is shown to include data storage devices 110. Data storage devices 110 may be any type of memory device capable of storing profile data, content item data, accounting data, or any other type of data used by log file processing system 114 or another component of computing system 100. Data storage devices 110 may include any type of non-volatile memory, media, or memory devices. For example, data storage devices 110 may include semiconductor memory devices (e.g., EPROM, EEPROM, flash memory devices, etc.) magnetic disks (e.g., internal hard disks, removable disks, etc.), magneto-optical disks, and/or CD ROM and DVD-ROM disks.

In some implementations, data storage devices 110 are local to content server 112, clutter assessment system 114, or content providers 106. In other implementations, data storage devices 110 are remote data storage devices connected with content server 112 and/or clutter assessment system 114 via network 102. In some implementations, data storage devices 110 are part of a data storage server or system capable of receiving and responding to queries from content server 112 and/or clutter assessment system 114.

In some implementations, data storage devices 110 are configured to store clutter metrics for resources 104. For example, data storage devices 110 may be a clutter statistics database configured to store clutter metrics for a plurality of resources 104. Clutter metrics may be stored in data storage devices 110 (e.g., by content server 112, by clutter assessment system 114, etc.) after being measured and reported by the injected measurement object. When a notification of an available impression is received at content server 112, content server 112 may retrieve clutter metrics from data storage devices 110 and expose the clutter metrics (or a signal based on the clutter metrics) to content providers 106.

Still referring to FIG. 1, computing system 100 is shown to include a content server 112. Content server 112 may receive a notification of an available impression from resources 104 and/or user devices 108. The notification of an available impression may be received in response to first-party content from resources 104 being viewed and/or loaded by user devices 108. The notification of an available impression may include a request for a third-party content item.

In some implementations, the notification of an available impression includes characteristics of one or more content slots in which a third-party content item will be displayed. For example, such characteristics may include the URL of the resource 104 in which the content slot is located, a display size of the content slot, a position of the content slot, and/or media types that are available for presentation in the content slot. If the content slot is located on a search results page, keywords associated with the search query may also be provided to content server 112. The characteristics of the content slot and/or keywords associated with the content request may facilitate identification of content items that are relevant to resources 104 and/or to the search query. Content server 112 may be configured to identify a particular resource with which the third-party content item will be displayed (e.g., by URL, by domain name, etc.).

Content server 112 may retrieve clutter metrics for the identified resource from data storage devices 110. The clutter metrics may include one or more clutter metrics previously generated for the identified resource and stored in data storage devices 110. Content server 112 may expose the available impression to content providers 106 and allow content providers 106 to bid on the available impression (e.g., programmatically as part of a real-time bidding system).

In some implementations, content server 112 exposes the clutter metrics for the identified resource to content providers 106 along with the available impression. Content providers 106 may choose to consider or ignore the clutter metrics when bidding on the available impression. In some implementations, content server 112 uses the clutter metrics to generate a quality signal. The quality signal may be based on the clutter metrics along with one or more other indications of an estimated return on investment associated with the impression (e.g., an established click-through-rate, a predicted click-through-rate, etc.). The quality signal may be a general quality signal for the identified resource, a particular quality signal for the available impression, or an individualized quality signal for the available impression and a particular third-party content item. Content server 112 may provide the quality signal to content providers 106 to consider when bidding on the available impression.

In some implementations, content server 112 uses the clutter metrics to generate an individualized quality signal for the available impression with respect to a particular third-party content item. Content server 112 may consider a plurality of factors when generating an individualized quality signal for a content item. For example, content server 112 may consider whether the third-party content item is relevant to the first-party resource content in conjunction with which the third-party content item would be presented. Content server 112 may generate a quality signal by comparing the keywords associated with the content item (e.g., specified by content providers 106, additional keywords extracted from the content item, etc.) with the keywords associated with the resource 104. A topic or type of content included in resources 104 may be used to establish keywords for resources 104.

In some implementations, content server 112 generates a quality signal for a content item by considering whether the content item is relevant to the user device 108 to which the content item will be presented. For example, content server 112 may compare the keywords associated with the content item with information (e.g., profile data, user preferences, etc.) associated with a particular user device 108 requesting the content item.

Content server 112 may auction the available impression to content providers 106. Content providers 106 may use the clutter metrics and/or quality signals to bid on the available impression. In some implementations, content server 112 automatically increases or decreases bid prices (e.g., starting bids, maximum bids, actual bids received from content providers 106, etc.) based on the quality metrics for the identified resource.

Content server 112 may select an eligible third-party content item based on a result of the auction. For example, content server 112 may select an eligible content item associated with the content provider that submits the highest bid. In some implementations, eligible content items include content items having characteristics matching the characteristics of the content slots in which the content items are to be presented. For example, content server 112 may select a content item having a display size which fits in a destination content slot. Content server 112 may resize a selected content item to fit a content slot or add additional visual content to the selected content item (e.g., padding, a border, etc.) based on the display size of the content item and the display size of the content slot. In some implementations, eligible content items include content items matching established user preferences for receiving individualized content; however, content server 112 may select a content item that does not match established user preferences if an insufficient number of preferred content items are available. Content server 112 may deliver the selected third-party content item to user devices 108 for presentation along with the first-party content from resources 104.

Still referring to FIG. 1, computing system 100 is shown to include a clutter assessment system 114. In some implementations, clutter assessment system 114 is a component of content server 112. In other implementations, content server 112 and clutter assessment system 114 are separate components. Clutter assessment system 114 may be configured to identify and expose a content element density and congestion of various resources 104 in conjunction with which third-party content items are presented.

A first-party resource may include a variety of content elements designed to capture the attention of a user (e.g., headlines, buttons, text snippets, logos, advertisements, etc.). Clutter assessment system 114 may automatically measure a clutter attribute of a first-party resource (e.g., a publisher's webpage) and generate a clutter metric for the resource based on the clutter attribute. Clutter attributes may include, for example, the size of a content slot in which a third-party content item is displayed relative to other content elements visible on the resource, the distance between the third-party content slot and other visual content elements, the number and/or density of visual content elements in proximity to the third-party content slot, and/or other visual attributes of the resource.

As an increasing number of users are viewing resource content via mobile devices (e.g., cell phones, tablets, etc.), many publishers of premium resource content are moving toward a more thoughtful and consistent design that errs toward minimalism. As such, the clutter metric for a first-party resource may be a relevant signal of the quality of the resource. Additionally, the clutter metric may be relevant to effectiveness of third-party content presented concurrently with the first-party resource.

Clutter assessment system 114 may automatically measure one or more clutter attributes of a resource using an asynchronous but concurrent measurement process. For example, clutter assessment system 114 may inject a measurement object into the content of a first-party resource while the resource is loading. In some implementations, clutter assessment system 114 injects the measurement object into the first-party resource along with a third-party content item (e.g., an advertisement selected by content server 112) when the resource is viewed/loaded by a user device 108. The measurement object may include, for example, multiple lines of JavaScript® code injected into the code of a webpage. The measurement object may be configured to wait until the resource has finished loading before measuring the one or more clutter attributes.

When the resource has fully loaded (e.g., on a user device, in a web browser, etc.), the measurement object may perform an assessment of the resource's clutter by measuring the one or more clutter attributes. In some implementations, the measurement object assesses the resource's clutter by parsing and analyzing a document object model for the resource. The measurement object may use the one or more clutter attributes of the resource to generate a clutter metric for the resource and report the clutter metric back to clutter assessment system 114.

Clutter assessment system 114 may store the clutter metric in a clutter statistics database (e.g., data storage devices 110). The next time an impression is available for the resource, content server 112 may retrieve the clutter metric from the clutter statistics database and expose the clutter metric to content providers 106 for use in bidding on the available impression. In various implementations, the clutter metric may be provided to third-party content providers 106 as part of a combined quality signal for the resource (e.g., combined with other factors relevant to bidding on the available impression) or as a separate signal (e.g., separate or independent from the other factors).

Clutter assessment system 114 may configure the injected measurement object to wait until the resource has fully loaded before measuring the one or more clutter attributes for the resource. By configuring the measurement object to wait until the resource has fully loaded, clutter assessment system 114 can obtain more accurate clutter metrics that closely track the visual appearance of the resource when viewed by a user device 108.

Upon each notification of an available impression for a resource, clutter assessment system 114 may cooperate with content server 112 to expose previously-generated clutter statistics for the resource to content providers 106 while measuring one or more clutter attributes for the resource in a separate concurrent but asynchronous process. For example, each time a third-party content item is served, the measurement object may be injected into the resource along with the third-party content item. When the resource has finished loading, the measurement object measures one or more clutter attributes for the resource and reports clutter metrics back clutter assessment system 114. Clutter assessment system 114 may store the clutter metrics in a clutter statistics database (e.g., data storage devices 110) for use by content providers 106 in bidding on subsequent impressions for the same resource.

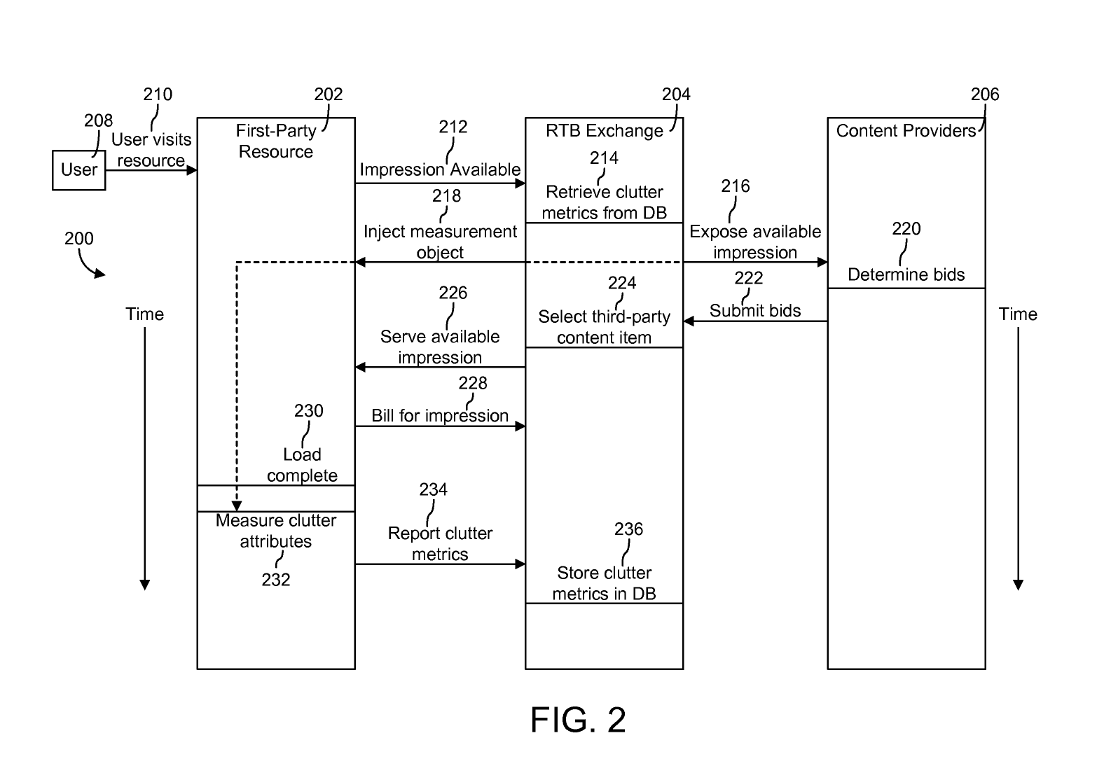

Referring now to FIG. 2, a flow diagram 200 illustrating a concurrent but asynchronous process for identifying and exposing content element density and congestion of a first-party resource is shown, according to a described implementation. Flow diagram 200 illustrates various interactions between a first-party resource 202, a real-time bidding (RTB) exchange 204, content providers 206, and a user 208. The various interactions may be direct (e.g., directly from first-party resource to RTB exchange 204, directly from RTB exchange 204 to content providers 206, etc.) or indirect (e.g., via network 102 or one or more intermediaries). Flow diagram 200 is also a timing diagram illustrating an order of the depicted interactions, according to a described implementation. In flow diagram 200, time progresses from top to bottom such that relatively earlier events are shown toward the top of flow diagram 200 and relatively later events are shown toward the bottom of flow diagram 200.

Flow diagram 200 is shown to include a user 208 visiting a first-party resource 202 (stage 210). First-party resource 202 may be the same or similar to resources 104 as previously described, with reference to FIG. 1. For example, first-party resource 202 may be a web page (e.g., a HTML web page, a PHP web page, etc.), a word processing document, a portable document format (PDF) document, an image, a video, a programming element, an interactive content source, a streaming video/audio source, or other resource of electronic information.

Stage 210 may include downloading and/or loading first-party resource content by user devices 108 (e.g., upon user 208 navigating to a webpage via a web browser executing on user devices 108). In some implementations, first-party resource 202 is a version or copy of an electronic resource (e.g., a webpage) that has been downloaded at least partially to user devices 108. User devices 108 may begin downloading first-party resource 202 in stage 210, but may not complete downloading and/or loading first-party resource 202 until later (e.g., in stage 230).

Still referring to FIG. 2, flow diagram 200 is shown to include first-party resource 202 notifying RTB exchange 204 of an available impression (stage 212). In some implementations, first-party resource 202 includes a content slot for presenting third-party content items. The content slot may cause first-party resource 202 to request a third-party content item when loaded by user devices 108. For implementations in which first-party resource 202 is a copy of an electronic resource downloaded to user devices 108, stage 212 may include user devices 108 notifying RTB exchange 204 of the available impression (e.g., via a web browser application executing on user devices 108). The notification of the available impression may include an indication of the first-party resource 202 with which the third-party content item will be presented. For example, the notification of the available impression may include a webpage URL.

RTB exchange 204 may incorporate the functionality of content server 112 and clutter assessment system 114, as previously described with reference to FIG. 1. For example, RTB exchange 204 may be an automated system configured to select third-party content items from content providers 206 for concurrent presentation with first-party content from resource 202. In stage 212, RTB exchange 204 receives the notification of the available impression from first-party resource 202.

Still referring to FIG. 2, flow diagram 200 is shown to include RTB exchange 204 retrieving clutter metrics from a clutter statistics database (stage 214). RTB exchange 204 may use the indication of the first-party resource (e.g., website URL) included in the notification of the available impression to retrieve one or more clutter metrics specific to first-party resource 202. The clutter metrics may reflect a previous assessment of the visual clutter of first-party resource 202. The clutter metrics may include one or more clutter metrics previously calculated for first-party resource 202 and stored in the clutter statistics database (e.g., during a previous iteration of the process illustrated in flow diagram 200).

RTB exchange 204 may be configured to programmatically auction the available impression to content providers 206. For example, RTB exchange 204 may expose the available impression to content providers 206 (stage 216). Exposing the available impression to content providers 206 may include providing content providers 206 with a quality score for first-party resource 202. The quality score may be based on the clutter metrics for first-party resource 202 retrieved from the clutter statistics database in stage 214. In various implementations, the clutter metrics may be provided to content providers 206 as part of a combined quality signal for first-party resource 202 (e.g., combined with other factors relevant to bidding on the available impression) or as a separate signal (e.g., separate or independent from the other factors).

Content providers 206 may consider the clutter metrics for first-party resource 202 and determine whether to bid on the available impression (stage 220). In some implementations, determining whether to bid on the available impression includes calculating an expected return on investment associated with the impression (e.g., an estimated click-through-rate, an estimated conversion rate, an expected value of the impression, etc.). Determining whether to bid may also include calculating a price to bid on the available impression. Content providers 206 may choose to consider or ignore the clutter metrics for first-party resource 202 when determining bids in stage 220. Content providers 206 may then submit bids to RTB exchange 204 (stage 222).

RTB exchange 204 may select a third-party content item based on a result of the auction (stage 224). For example, RTB exchange 204 may select a third-party content item associated with the content provider 206 that submits the highest bid for the available impression in stage 222. RTB exchange 204 may then serve the available impression (stage 226) by causing the selected third-party content item to be presented in conjunction with first-party resource 202. First-party resource 202 may bill RTB exchange 204 for the impression (stage 228), which is subsequently paid by content providers 206.

Still referring to FIG. 2, RTB exchange 204 may inject a measurement object into first-party resource 202 (stage 218). Stage 218 may be performed concurrently with stage 216 (i.e., prior to auctioning the available impression to content providers 206) or any time between the time at which the notification of the available impression is received by RTB exchange 204 (stage 212) and the time at which first-party resource 202 finishes loading (stage 230). In other words, the measurement object may be injected into the content of first-party resource 202 at any time while first-party resource 202 is loading. In some implementations, the measurement object is injected into first-party resource 202 along with the third-party content item selected by RTB exchange 204 as a result of the auction.

In some implementations, the measurement object includes computer-executable code for measuring one or more clutter attributes of first-party resource 202. For example, the measurement object may include multiple lines of code (e.g., JavaScript® code) injected into the HTML or PHP content of a webpage. The measurement object may be run by user devices 108 by executing the code contained therein.

In some implementations, the measurement object is configured to wait until first-party resource 202 has finished loading (stage 230) before assessing the visual clutter of first-party resource 202. By waiting until first-party resource 202 has fully loaded, the measurement object can more accurately analyze the visual appearance of first-party resource 202 as viewed by user 208.

Upon first-party resource 202 fully loading (stage 230), the measurement object may proceed to measure one or more clutter attributes of first-party resource 202 (stage 232). In some implementations, the measurement object measures clutter attributes by parsing and analyzing a document object model for first-party resource 202. The measurement object may use the one or more clutter attributes of the resource to generate a clutter metric for first-party resource 202 and report the clutter metric to RTB exchange 204 (stage 234). RTB exchange may store the clutter metric in the clutter statistics database for use the next time an impression is available for first-party resource 202.

One challenge of delivering clutter metrics to content providers 206 as part of a real time bidding process is that clutter can only be measured after first-party resource 202 has fully loaded (i.e., after stage 230). However, by the time that first-party resource 202 has fully loaded, the opportunity to serve the impression has passed. RTB exchange 204 addresses this challenge by serving a third-party content item based on previously-generated clutter statistics (e.g., the serving process described in stages 214-228) while measuring clutter in a separate concurrent but asynchronous process (e.g., the clutter measurement process described in stages 218 and 230-236) while). For example, each time a third-party content item is served, the measurement object may be injected into the content of first-party resource 202 along with the third-party content item. When resource 202 has finished loading, the measurement object measures the visual clutter of first-party resource 202 and reports clutter metrics back to RTB exchange 204. The clutter metrics are stored in the clutter statistics database and used for bidding on subsequent impressions for the same first-party resource 202.

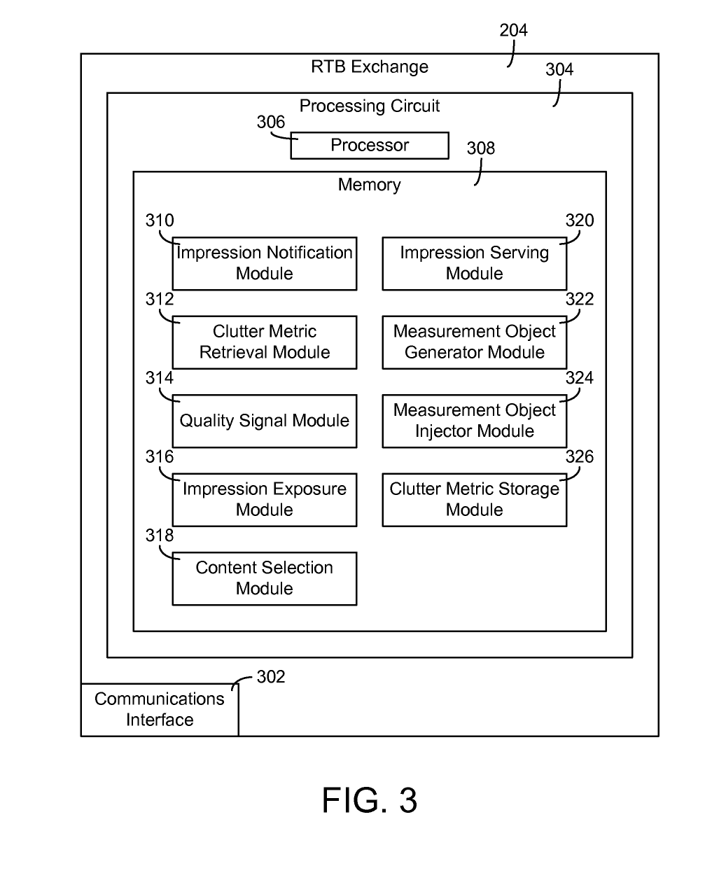

Referring now to FIG. 3, a block diagram illustrating RTB exchange 204 in greater detail is shown, according to a described implementation. In brief overview, RTB exchange 204 may be configured receive a notification of an available impression from first-party resource 202 and to expose the available impression to content providers 206. RTB exchange 204 may retrieve a clutter metric for first-party resource 202 from a clutter statistics database and provide the clutter metric to content providers 206 when exposing the available impression. RTB exchange 204 may auction the available impression to content providers 206 and select a third-party content item based on a result of the auction. RTB exchange 204 may serve the available impression by causing the selected third-party content item to be presented along with first-party resource 202.

In a separate concurrent but asynchronous process, RTB exchange 204 may inject a measurement object into first-party resource 202. The measurement object may be configured to measure one or more clutter attributes of first-party resource 202 and to generate a clutter metric based on the clutter attributes. In some implementations, the measurement object is configured (e.g., by RTB exchange 204) to wait until first-party resource 202 has finished loading before measuring the one or more clutter attributes. The measurement object may report the clutter metric to RTB exchange 204 and RTB exchange may store the clutter metric in the clutter statistics database.

Still referring to FIG. 3, RTB exchange 204 is shown to include a communications interface 302 and a processing circuit 304. Communications interface 302 may include wired or wireless interfaces (e.g., jacks, antennas, transmitters, receivers, transceivers, wire terminals, Ethernet ports, WiFi transceivers, etc.) for conducting data communications with local or remote devices or systems. For example, communications interface 302 may allow RTB exchange 204 to communicate with first-party resource 202, content providers 206, and other components of computing system 100 (e.g., network 102, user devices 108, data storage devices 110, etc.).

Processing circuit 304 is shown to include a processor 306 and memory 308. Processor 306 may be implemented as a general purpose processor, an application specific integrated circuit (ASIC), one or more field programmable gate arrays (FPGAs), a CPU, a GPU, a group of processing components, or other suitable electronic processing components.

Memory 308 may include one or more devices (e.g., RAM, ROM, flash memory, hard disk storage, etc.) for storing data and/or computer code for completing and/or facilitating the various processes, layers, and modules described in the present disclosure. Memory 308 may include volatile memory or non-volatile memory. Memory 308 may include database components, object code components, script components, or any other type of information structure for supporting the various activities and information structures described in the present disclosure. In some implementations, memory 308 is communicably connected to processor 306 via processing circuit 304 and includes computer code (e.g., data modules stored in memory 308) for executing one or more processes described herein. Memory 308 is shown to include an impression notification module 310, a clutter metric retrieval module 312, a quality signal module 314, an impression exposure module 316, a content selection module 318, an impression serving module 320, a measurement object generator module 322, a measurement object injector module 324, and a clutter metric storage module 326.

Still referring to FIG. 3, memory 308 is shown to include an impression notification module 310. Impression notification module 310 may be configured to receive a notification of an available impression from a first-party resource (e.g., resources 104, first-party resource 202, etc.) and/or from user devices 108. For example, first-party resources may include one or more content slots for presenting third-party content items. The content slots may cause first-party resources to request a third-party content item when loaded by user devices 108.

In some implementations, impression notification module 310 receives a notification of an available impression from user devices 108. For example, when user devices 108 load a first-party resource, an embedded content slot in the first-party resource may cause user devices 108 to request a third-party content item to fill the content slot from RTB exchange 204. User devices 108 may notify impression notification module 310 of an available impression by requesting a third-party content item from RTB exchange 204. The notification of the available impression may include an indication of the first-party resource with which the third-party content item will be presented. For example, the notification of the available impression may include a webpage URL, a document URL, a domain name, or other indication of a particular first-party resource.

Still referring to FIG. 3, memory 308 is shown to include a clutter metric retrieval module 312. Clutter metric retrieval module 312 may be configured to retrieve one or more clutter metrics for the first-party resource from a clutter statistics database. In some implementations, clutter metric retrieval module 312 retrieves clutter metrics from the clutter statistics database in response to impression notification module 310 receiving a notification of an available impression. Clutter metric retrieval module 312 may retrieve one or more clutter metrics specific to a particular first-party resource. For example, clutter metric retrieval module 312 may use the indication of the first-party resource included with the notification of the available impression to identify a particular first-party resource and to retrieve clutter metrics specific to the identified first-party resource.

Clutter metric retrieval module 312 may retrieve clutter metrics that reflect a previous clutter measurement and/or calculation for the identified first-party resource. The clutter metrics may represent a most recent measurement of clutter data for the identified first-party resource, an average of multiple clutter measurements for the identified first-party resource, or any other computation of clutter data available for the identified first-party resource (e.g., clutter data for a similar URL within the same domain, a weighted average and/or moving average of historical clutter data, etc.). Clutter metric retrieval module 312 may retrieve clutter metrics that have been previously-generated and stored by RTB exchange 204 (e.g., by clutter metric storage module 326) during a previous asynchronous clutter measurement process.

A first-party resource may include a variety of content elements designed to capture the attention of a user (e.g., headlines, buttons, text snippets, logos, advertisements, etc.). As an increasing number of users are viewing resource content via mobile devices (e.g., cell phones, tablets, etc.), many publishers of premium resource content are moving toward a more thoughtful and consistent design that errs toward minimalism. As such, the clutter metric for a first-party resource may be a relevant signal of the quality of the resource. Additionally, the clutter metric may be relevant to effectiveness of third-party content presented concurrently with the first-party resource. For example, the clutter metrics may relate to the visibility and/or notoriety of a third-party content item presented in conjunction with the identified first-party resource.

In some implementations, the clutter metrics represent the visual clutter of content elements presented in a fully loaded view of the identified first-party resource (e.g., content element density, content element congestion, etc.). Clutter metrics may include, for example, the size of a content slot in which a third-party content item can be displayed relative to other content elements visible on the resource, the distance between the third-party content slot and other visual content elements, the number and/or density of visual content elements in proximity to the third-party content slot, and/or other visual attributes of the resource.

Still referring to FIG. 3, memory 308 is shown to include a quality signal module 314. Quality signal module 314 may be configured to generate a quality signal or quality score based on the clutter metrics retrieved for the identified first-party resource. The quality signal may be based on the clutter metrics along with one or more other indications of an estimated return on investment associated with the available impression (e.g., an established click-through-rate, a predicted click-through-rate, etc.). The quality signal may be a general quality signal for the identified resource, a particular quality signal for the available impression, or an individualized quality signal for the available impression and a particular third-party content item. RTB exchange 204 may provide the quality signal to content providers 206 to consider when bidding on the available impression.

In some implementations, quality signal module 314 uses the clutter metrics to generate an individualized quality signal for the available impression with respect to a particular third-party content item. Quality signal module 314 consider a plurality of factors when generating an individualized quality signal for a content item. For example, quality signal module 314 may consider whether the third-party content item is relevant to the first-party resource content in conjunction with which the third-party content item would be presented. Quality signal module 314 may generate a quality signal by comparing the keywords associated with the content item (e.g., specified by content providers 106, additional keywords extracted from the content item, etc.) with the keywords associated with the identified first-party resource. A topic or type of content included in the first-party resource may be used to establish keywords for the resource.

In some implementations, quality signal module 314 generates a quality signal for a content item by considering whether the content item is relevant to the user device 108 to which the content item will be presented. For example, quality signal module 314 may compare the keywords associated with the content item with information (e.g., profile data, user preferences, etc.) associated with a particular user device 108 requesting the content item.

In some implementations, quality signal module 314 generates a single quality signal based at least partially on the clutter metrics for the identified first-party resource. In other implementations, quality signal module generates multiple quality signals. For example, quality signal module 314 may generate a first quality signal that is based on the clutter metrics and a second quality signal that is not based on the clutter metrics. The first quality signal may directly reflect the clutter metrics for the identified first-party resource without considering any other factors (e.g., keywords, relevancy, user interests, etc.). By providing content providers 206 with a quality signal that is based on clutter metrics and another quality signal that is not based on clutter metrics, content providers 206 can choose to consider or ignore the clutter metrics when bidding on the available impression.

Still referring to FIG. 3, memory 308 is shown to include an impression exposure module 316. Impression exposure module 316 may be configured to expose the available impression to content providers 206. Exposing the available impression to content providers 206 may include auctioning the available impression to group of content providers 206 in real-time (e.g., as part of a programmatic bidding process). For example, impression exposure module 316 may present the available impression to content providers 206 along with one or more quality signals or quality scores generated by quality signal module 314. Content providers 206 can bid on the available impression in a programmatic auction conducted in real-time.

In a programmatic auction, content providers 206 may be represented by programming elements configured to advance the bidding strategies of various content providers 206. For example, content providers 206 can specify a maximum permissible bid for each available impression, a total bidding budget for a specified time period (e.g., $10,000 per month), threshold levels for various metrics defining whether to bid on an available impression (e.g., keyword matches, geographic limiters, user interest matches, expected return on investment, predicted click-through-rate, etc.), or other campaign parameters relating to the bidding strategies employed during a programmatic auction.

In some implementations, impression exposure module 316 automatically increases or decreases bid prices (e.g., starting bids, maximum bids, actual bids received from content providers 206, cost per impression (CPI or CMP) rates, etc.) based on the quality signals for the identified resource. Impression exposure module 316 may determine a winner of the auction (e.g., a winning content provider, a winning content item, etc.). In some implementations, impression exposure module 316 determines a winner by determining which content provider and/or content item placed the highest bid for the available impression.

Still referring to FIG. 3, memory 308 is shown to include a content selection module 318. Content selection module 318 may be configured to select an eligible third-party content item based on a result of the auction. For example, content selection module 318 may select an eligible content item associated with the content provider that submits the highest bid. In some implementations, eligible content items include content items having characteristics matching the characteristics of the content slots in which the content items are to be presented. For example, content selection module 318 may select a content item having a display size which fits in a destination content slot.

In some implementations, content selection module 318 selects a third-party content item by comparing an expected return on investment associated with each of a set of eligible content items. For example, content selection module 318 may compare an established click-through-rate, a predicted click-through-rate, an estimated conversion rate, a relevancy rate, or other performance metrics associated with a plurality of potential content items (e.g., in order to maximize performance and/or value for the winning content provider). Content selection module 318 may select an eligible third-party content item that satisfies the content distribution parameters of the winning content provider. In some implementations, content selection module 318 selects a third-party content item that matches established user preferences for receiving individualized content. However, if an insufficient number of preferred content items are available, content selection module 318 may select a content item that does not match established user preferences.

Still referring to FIG. 3, memory 308 is shown to include an impression serving module 320. Impression serving module 320 may be configured to serve the available impression for the identified first-party resource. Impression serving module 320 may deliver the selected third-party content item to user devices 108 and/or first party resource 202 for presentation along with first-party content from resource 202. In some implementations, impression serving module 320 may resize a selected content item to fit a content slot or add additional visual content to the selected content item (e.g., padding, a border, etc.) based on the display size of the content item and the display size of the content slot. Impression serving module 320 may determine whether additional third-party content items can be presented in the same content slot (e.g., based on the display size of the selected content item.) Impression serving module 320 may resize, reshape, or otherwise adjust multiple third-party content items for concurrent presentation in a single content slot.

Impression serving module 320 may interact with first-party resource 202 and/or user devices 108 to determine whether the selected third-party content item was successfully presented. Impression serving module 320 may receive a notification of successful presentation and account for the served impression. Accounting for a served impression may include causing payment to the identified first-party resource 202 and billing the winning content provider for the opportunity to present a third-party content item.

Still referring to FIG. 3, memory 308 is shown to include a measurement object generator module 322. Measurement object generator module 322 may create a measurement object configured to automatically assess the visual clutter (e.g., content element density, content element congestion, etc.) of a first-party resource 202. In some implementations, the measurement object is a software object including computer-executable code for measuring one or more clutter attributes of first-party resource 202. For example, the measurement object may include multiple lines of computer-readable code (e.g., JavaScript® code) that can be injected into the content of a webpage or other electronic resource.

In some implementations, measurement object generator module 322 configures the measurement object to wait (e.g., delay, pause, not run, etc.) until first-party resource 202 has fully loaded before assessing the visual clutter of first-party resource 202. Measurement object generator module 322 may configure the measurement object to monitor the load progress of first-party resource 202 (e.g., in a web browser of user devices 108) and to delay assessment of the visual clutter until loading has completed. By waiting until first-party resource 202 has fully loaded before performing a clutter assessment, the measurement object can more accurately analyze the visual appearance of first-party resource 202 in its fully loaded form, as viewed by a user.

Measurement object generator module 322 may configure the measurement object to measure one or more clutter attributes of first-party resource 202. In some implementations, the measurement object measures the one or more clutter attributes by traversing a document object model (DOM) for first-party resource 202. One clutter attribute that the measurement object can measure is the number of visible DOM elements on first-party resource 202. Visible DOM elements may include, for example, text (e.g., <p>, <h1>, <a>, etc.), image (e.g., <img>), shapes, (e.g., <rect>, <ellipse>, etc.), video (e.g., <video>), and/or other content elements visible to a viewer. Visible content elements may include a variety of content elements such as headlines, buttons, text snippets, logos, advertisements, and other items displayed visually on first-party resource 202.

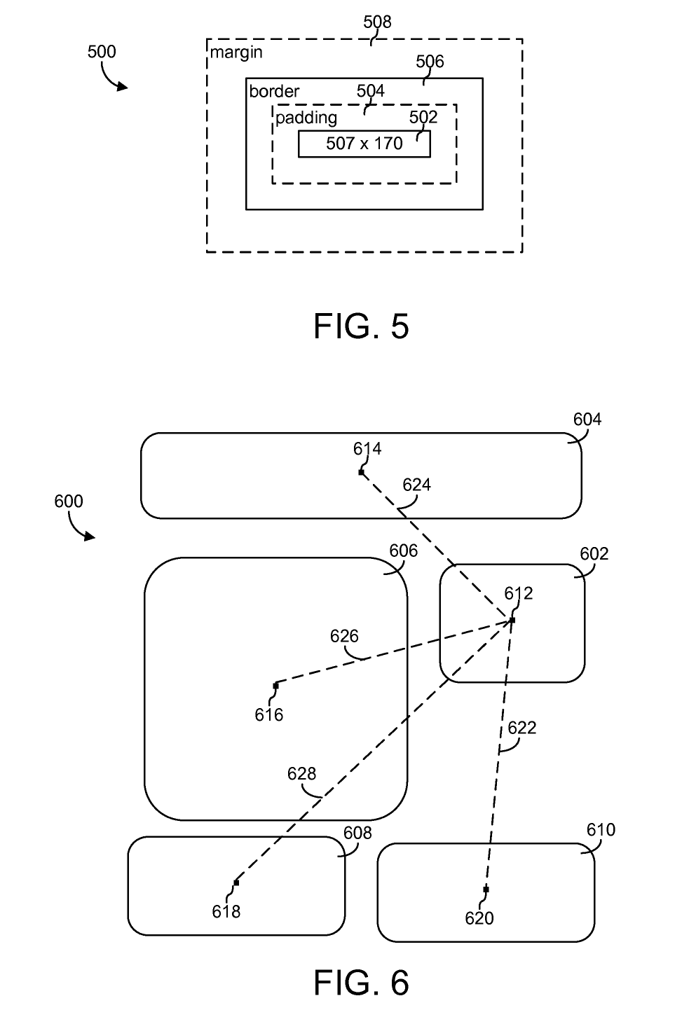

The number of visible DOM elements can be measured by extracting attribute information from the DOM tree for first-party resource 202. The attributes of a content element may contain information about the element's display size (e.g., width and height), as well as other information about how the content element is displayed on first-party resource 202. For example, the attributes of a content element may contain padding, border, and/or margin measurements. Padding, border, and margin measurements may be used to add spacing between adjacent content elements in first-party resource 202. An example of a content element with padding, border, and margin information is described in greater detail with reference to FIG. 5.

Another clutter attribute that the measurement object can measure is the display size of a content slot in which the third-party content item delivered by RTB exchange 204 is presented relative to other visual elements surrounding the content slot on first-party resource 202. For example, the measurement object may be configured to measure a display size (e.g., 120×600 pixels, 300×200 pixels, 1×4 inches, etc.) of a third-party content slot on first-party resource 202. The measurement object may also measure a display size of the nearest visual element above the content slot, below the content slot, to the left of the content slot, to the right of the content slot, and/or otherwise surrounding the content slot in which a third-party content item can be displayed. The measurement object may compare the display size of the third-party content slot to the display sizes of the surrounding content elements (e.g., average display size, combined display size, etc.) to determine a relative display size of the third-party content slot. In various implementations, the display size for a content element may be the actual display size of the content element or the actual display size plus a padding area, a border area, and/or a margin area around the content element.

In some implementations, the measurement object is configured to measure the distance between the third-party content slot and one or more of the closest visual elements surrounding the third-party content slot (e.g., other content elements in the visible area around the third-party content slot). For example, the measurement object may parse the DOM for first-party resource 202 to determine a distance between a centroid (i.e., a geometric center) of the third-party content slot and the centroids of other content elements. Centroid coordinates can be calculated by extracting position coordinates (e.g., upper left, upper right, lower left, and lower right) for each content element displayed on first-party resource 202. An example of a centroid spacing measurement is described in greater detail with reference to FIG. 6.

In some implementations, the measurement object is configured to measure the display size of the third-party content slot relative to the viewable surroundings of first-party resource 202. In some implementations, the viewable surroundings of first-party resource 202 are defined by the display size of a static window in which the third-party content slot is located. The display size of the static window may be the display size of a webpage or other first-party resource containing the third-party content slot. In some implementations, the display size of the viewable surroundings is a predetermined area corresponding to the area of first-party resource 202 that is concurrently visible when rendered by a web browser or other resource viewer (e.g., 1900×1080 pixels, 1280×720 pixels, etc.). In some implementations, the display size of the viewable surroundings is based on the document object model for first-party resource 202.

In some implementations, the measurement object is configured to measure the number, size, and/or density of visual content elements displayed on first-party resource 202 in the viewable area surrounding the third-party content slot. For example, the measurement object may measure a display size of each content element in the viewable surroundings and calculate a total display size by combining the display sizes of each content element. The measurement object may compare the total display size of all the content elements to the display size of the viewable surroundings to determine a proportion of the viewable surroundings that is occupied by visual content elements (e.g., a content element density). The measurement object may calculate a number and/or display size of the visual content elements in the viewable surroundings relative to the display size of the third-party content slot. Although only a few clutter attributes are described in detail, it should be understood that the measurement object can be configured to measure any number or type of clutter attributes that can be determined by visual inspection of first-party resource 202 and/or by parsing the document object model for first-party resource 202.

Measurement object generator module 322 may configure the measurement object to generate a clutter metric for first-party resource 202 based on the one or more measured clutter attributes. For example, the clutter metric may be a function of a plurality of clutter attributes. In various implementations, the clutter metric represents an overall content element density and/or content element congestion in the viewable area surrounding a content slot in which a third-party content item can be displayed or immediately adjacent to the content slot in which a third-party content item can be displayed. The measurement object may generate a single clutter metric that is a function of one or more of the measured clutter attributes or multiple clutter metrics (e.g., one for each measured clutter attribute).

In some implementations, the measurement object generates a single clutter metric that is a function of a plurality of measured clutter attributes. For example, the measurement object may calculate a density index for first-party resource 202 using the formula:

$$Density Index = \frac{{\sum }_{i = 1}^{Num - 1} \frac{Net * {Dis}_{i}}{Tps}}{Num - 1}$$

where Num is the number of visible DOM elements, Tps is the total page size, Net is the net area size of visible DOM elements (e.g., actual area, area with padding, border, margin, etc.), and Dis_{g} is the distance between the third-party content slot and the ith content element displayed on first-party resource 202.

In some implementations, the measurement object generates one or more clutter metrics by processing the various measured clutter attributes. For example, if one of the clutter attributes measured by the measurement object is the display size of a content slot in which the third-party content item delivered by RTB exchange 204 is presented, the measurement object can generate a first clutter metric indicating the display size of the content slot relative to other visual elements surrounding the content slot on first-party resource 202. The first clutter metric may be a number corresponding to the relative display size of the third-party content slot. For example, if the display size of the third-party content slot is approximately one-fourth the display size of the surrounding content elements, the clutter measurement object may generate a “relative display size” clutter metric of 0.25 (e.g., rel_size=0.25).

As another example, if one of the clutter attributes measured by the clutter measurement object is the average distance between the third-party content slot and the surrounding content elements, the measurement object can generate a second clutter metric indicating the average distance (e.g., in pixels, in inches, in em, etc.). The second clutter metric may be a number corresponding to the average distance between the content slot and surrounding content elements. For example, if the average distance between the third-party content slot and the surrounding content elements is 684 pixels, the clutter measurement object may generate an “average distance to surrounding elements” clutter metric of 684 (e.g., avg_dist=684).

As another example, if one of the clutter attributes measured by the measurement object is the number of content elements in the viewable surroundings of the third-party content slot, the measurement object can generate a third clutter metric indicating the measured number of surrounding content elements. For example, if the number of surrounding content elements in the viewable area is three, the clutter measurement object may generate a “number of viewable elements” clutter metric of 3 (e.g., viewable elements=3).

As yet another example, if one of the clutter attributes measured by the measurement object is the density of content elements in the viewable surroundings of the third-party content slot, the measurement object can generate a fourth clutter metric indicating the density of surrounding content elements. For example, if the surrounding content elements occupy 72% of the viewable area around the third-party content slot, the clutter measurement object may generate a “density of viewable elements” clutter metric of 0.72 (e.g., density=0.72).

In some implementations, the clutter measurement object normalizes each of the generated clutter metrics to a uniform scale (e.g., between zero and one) such that a value of one corresponds to the maximum possible value of the clutter metric and a value of zero corresponds to the minimum possible value of the clutter metric. In some implementations, the clutter measurement object combines multiple clutter metrics into a combined clutter metric for first-party resource 202. For example, the clutter measurement object may average multiple clutter metrics and/or the normalized values thereof. The values of each clutter metric in the average can be weighted based on the relative importance of the clutter metric to the overall visual clutter of first-party resource 202. The weights assigned to each clutter metric can be adjusted in various implementations. The clutter metrics can be stored as attributes of first-party resource 202 in the clutter statistics database.

The clutter metric may indicate a visibility or notoriety of a third-party content item presented in conjunction with first-party resource 202 and may correlate with the performance of the third-party content item. For example, if a resource includes many content elements (e.g., headlines, buttons, text snippets, logos, advertisements, etc.) in the area surrounding the third-party content slot, the visual impact of the third-party content item may be negatively affected due to the increased likelihood for the surrounding content elements to draw attention away from the third-party content item. Conversely, if a resource includes relatively few content elements in the area surrounding the third-party content slot, the visual impact of the third-party content item may be unaffected or even improved.

In various implementations, measurement object generator module 322 may create the measurement object in response to receiving a notification of an available impression (e.g., by impression notification module 310) or may create the measurement object in advance (e.g. prior to receiving the notification of an available impression). In some implementations, measurement object generator module 322 creates the measurement object based on one or more attributes of the first-party resource for which the measurement object will assess visual clutter. For example, measurement object generator module 322 may generate a measurement object based on the style or format of first-party resource (e.g., a HTML or PHP webpage, a PDF document, etc.). In other implementations, measurement object generator module 322 creates a global measurement object for all formats and/or types of resources. Measurement object generator module 322 may configure the measurement object to report the clutter metric to RTB exchange 204.

Still referring to FIG. 3, memory 308 is shown to include a measurement object injector module 324. Measurement object injector module 324 may be configured to inject the measurement object into the content of first-party resource 202. Injecting the measurement object into the content of first-party resource 202 may include adding multiple lines of computer-executable code into preexisting code of first-party resource 202. In some implementations, the measurement object may be injected into a portion of first-party resource 202 configured to receive a third-party content item (e.g., into a content slot of resource 202). Measurement object injector module 324 may inject the measurement object into first-party resource 202 in conjunction with a third-party content item (e.g., as part of an ad serving process).

In some implementations, measurement object injector module 324 injects the measurement object at approximately the same time that impression exposure module 316 exposes the available impression to content providers 206 (e.g., prior to auctioning the available impression to content providers 206). In other implementations, measurement object injector module 324 injects the measurement object at any time between the time at which the notification of the available impression is received and the time at which first-party resource 202 finishes loading. In other words, measurement object injector module 324 may inject the measurement object into the content of first-party resource 202 at any time while first-party resource 202 is loading. In some implementations, measurement object injector module 324 injects the measurement object into first-party resource 202 along with the third-party content item selected by content selection module 318.

The measurement object may be executed or run by user devices 108 and/or first-party resource 202 by executing the code contained therein. Once first-party resource 202 has finished loading, the measurement object may automatically measure one or more clutter attributes and calculate a clutter metric for first-party resource 202. The measurement object may then report the clutter metric to RTB exchange 204.

Still referring to FIG. 3, memory 308 is shown to include a clutter metric storage module 326. Clutter metric storage module 326 may be configured to receive a clutter metric from an injected measurement object (e.g., executing on user devices 108 and/or first-party resource 202). Clutter metric storage module 326 may identify a particular resource associated with the clutter metric reported by the measurement object (e.g., based on indicia received from the measurement object, based on metadata included in the report, etc.).

Clutter metric storage module 326 may store and/or update the clutter metric for the identified resource in the clutter statistics database. In various implementations, clutter metric storage module 326 replaces a previous clutter metric value with an updated value or stores the updated clutter metric along with one or more previous clutter metrics for the identified resource (e.g., without replacement). A set of clutter metrics for the same first-party resource may be useful in determining an average clutter metric for the resource or to perform any other computation and/or compilation of clutter data. Clutter metric storage module 326 may store the clutter metric along with an indication of the first-party resource associated with the clutter metric (e.g., a webpage URL, a domain, etc.). Indicia of the first-party resource associated with the clutter metric may be used (e.g., by clutter metric retrieval module 312) to retrieve the clutter metric from the clutter statistics database the next time an impression is available for the same first-party resource.

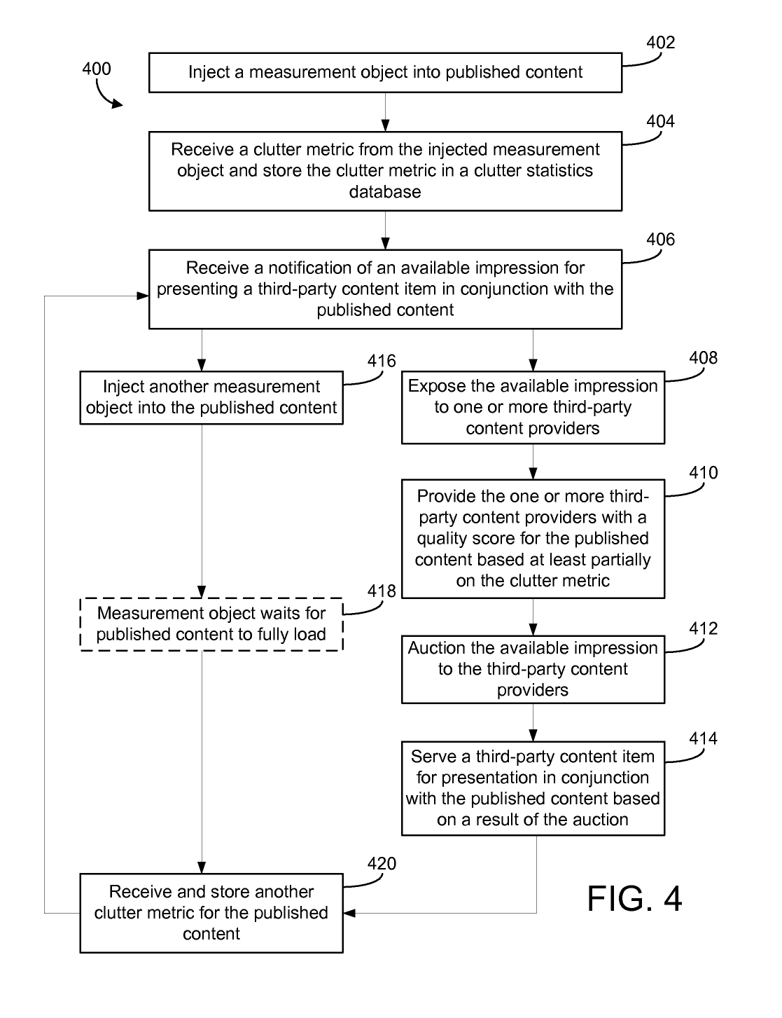

Referring now to FIG. 4, a flowchart of a process 400 for identifying and exposing content element density and congestion is shown, according to a described implementation. In some implementations, process 400 is performed by RTB exchange 204, as described with reference to FIGS. 2-3. Process 400 can be a concurrent but asynchronous process for both measuring the clutter of a first-party resource and serving third-party content for concurrent presentation with the first-party resource. For example, process 400 can measure the clutter attributes of a first-party resource while concurrently serving a third-party content item to the resource. The clutter metrics obtained while serving the third-party content item can be stored and provided to third-party content providers (e.g., as part of a quality signal) when serving the next third-party content item to the resource. Each time a third-party content item is served to the resource, clutter can be concurrently measured and stored for use in serving the next third-party content item.

Still referring to FIG. 4, process 400 is shown to include injecting a measurement into published content (stage 402). The measurement object may be configured to automatically assess the visual clutter (e.g., content element density, content element congestion, etc.) of published content. Published content can include first-party resource content (e.g., resource 202) as well as any third-party content presented concurrently with the first-party content. In some implementations, the measurement object is a software object including computer-executable code for measuring one or more clutter attributes. For example, the measurement object may include multiple lines of computer-readable code that can be injected into the code of a webpage or other published content. In some implementations, the measurement object is configured to wait (e.g., delay, pause, not run, etc.) until the published content has fully loaded before assessing the visual clutter thereof.

The measurement object may be configured to measure one or more clutter attributes the published content. Clutter attributes may include, for example, the size of a content slot in which a third-party content item can be displayed relative to other content elements visible on the published content, the distance between the third-party content slot and other visual content elements, the number and/or density of visual content elements in proximity to the third-party content slot, and/or other visual attributes of the published content. In some implementations, the measurement object measures the one or more clutter attributes by parsing and analyzing a document object model for the published content.

In some implementations, injecting the measurement object into the published content includes adding multiple lines of computer-executable code into preexisting code of the published content. In some implementations, stage 402 includes injecting the measurement object into a portion the published content configured to receive a third-party content item (e.g., into a content slot). Stage 402 may be performed while serving a third-party content item for concurrent presentation with the published content.

Still referring to FIG. 4, process 400 is shown to include receiving a clutter metric from the injected measurement object and storing the clutter metric in a clutter statistics database (stage 404). The measurement object may be configured to generate the clutter metric for the published content based on the one or more measured clutter attributes. For example, the clutter metric may be a function of a plurality of clutter attributes. In various implementations, the clutter metric represents an overall content element density and/or content element congestion in the viewable area surrounding a content slot in which a third-party content item can be displayed or immediately adjacent to the content slot in which a third-party content item can be displayed.

The clutter metric may indicate a visibility or notoriety of a third-party content item presented in conjunction with the published content and may correlate with the performance of the third-party content item. For example, if the published content includes many content elements (e.g., headlines, buttons, text snippets, logos, advertisements, etc.) in the area surrounding the third-party content slot, the visual impact of the third-party content item may be negatively affected due to the increased likelihood for the surrounding content elements to draw attention away from the third-party content item. Conversely, if the published content includes relatively few content elements in the area surrounding the third-party content slot, the visual impact of the third-party content item may be unaffected or even improved.

In some implementations, stage 404 includes identifying a particular resource associated with the clutter metric reported by the measurement object (e.g., based on indicia received from the measurement object, based on metadata included in the report, etc.). Stage 404 may include storing the clutter metric along with an indication of the first-party resource associated with the clutter metric (e.g., a webpage URL, a domain, etc.). Indicia of the first-party resource associated with the clutter metric may be used (e.g., by clutter metric retrieval module 312) to retrieve the clutter metric from the clutter statistics database the next time an impression is available for the same first-party resource.

In various implementations, stage 404 includes replacing a previous clutter metric value with an updated value or storing the updated clutter metric along with one or more previous clutter metrics for the identified resource (e.g., without replacement). A set of clutter metrics for the same first-party resource may be useful in determining an average clutter metric for the resource or to perform any other computation and/or compilation of clutter data.

Still referring to FIG. 4, process 400 is shown to include receiving a notification of an available impression for presenting a third-party content item in conjunction with the published content (stage 406). Stage 406 may be performed, for example, in response to a user loading or viewing the published content. The published content may include one or more content slots for presenting third-party content items. The content slots may cause the published content to request a third-party content item when loaded by user devices 108.

In some implementations, stage 406 includes receiving a notification of an available impression from user devices 108. For example, when user devices 108 load the published content, an embedded content slot may cause user devices 108 to request a third-party content item to fill the content slot from RTB exchange 204. User devices 108 may notify RTB exchange 204 of an available impression by requesting a third-party content item from RTB exchange 204. The notification of the available impression may include an indication of the published content with which the third-party content item will be presented. For example, the notification of the available impression may include a webpage URL, a document URL, a domain name, or other indication of particular published content.

Still referring to FIG. 4, process 400 is shown to include exposing the available impression to one or more third-party content providers (stage 408) and providing the one or more third-party content providers with a quality score for the published content (stage 410). The quality score may be based at least partially on the clutter metric. In some implementations, stages 408-410 include retrieving the previously-stored clutter metric for the published content from the clutter statistics database. The previously-stored clutter metric may reflect a previous clutter measurement and/or calculation for the published content.

In some implementations, multiple clutter metrics may be retrieved from the clutter statistics database. The clutter metrics may represent a most recent measurement of clutter data for the published content, an average of multiple clutter measurements for the published content, or any other computation of clutter data available for the published content (e.g., clutter data for a similar URL within the same domain, a weighted average and/or moving average of historical clutter data, etc.).

Providing the third-party content providers with a quality score for the published content may include generating a quality signal or quality score based on the clutter metrics retrieved from the clutter statistics database. The quality score may be based on the clutter metrics along with one or more other indications of an estimated return on investment associated with the available impression (e.g., an established click-through-rate, a predicted click-through-rate, etc.). The quality score may be a general quality score for the published content, a particular quality score for the available impression, or an individualized quality score for the available impression and a particular third-party content item. Stage 410 may include providing the quality score to the third-party content providers to consider when bidding on the available impression.

Still referring to FIG. 4, process 400 is shown to include auctioning the available impression to the third-party content providers (stage 412). Stage 412 may include auctioning the available impression to group of third-party content providers in real-time as part of a programmatic bidding process. For example, stage 412 may include presenting the available impression to the third-party content providers along with one or more quality signals or quality scores associated with the available impression. The third-party content providers can bid on the available impression in a programmatic auction conducted in real-time.

In a programmatic auction, the third-party content providers may be represented by programming elements configured to advance the bidding strategies of the third-party content providers. For example, the third-party content providers can specify a maximum permissible bid for each available impression, a total bidding budget for a specified time period (e.g., $10,000 per month), threshold levels for various metrics defining whether to bid on an available impression (e.g., keyword matches, geographic limiters, user interest matches, expected return on investment, predicted click-through-rate, etc.), or other campaign parameters relating to the bidding strategies employed during a programmatic auction. In some implementations, stage 412 includes automatically incrementing or decrementing bid prices (e.g., starting bids, maximum bids, actual bids received from the third-party content providers, cost per impression (CPI or CMP) rates, etc.) based on the quality score and/or clutter metric for the published content.

Stage 412 may include determining a winner of the auction (e.g., a winning content provider, a winning content item, etc.). In some implementations, stage 412 includes selecting a winner by determining which content provider and/or content item placed the highest bid for the available impression. The third-party content provider associated with the highest bid may be determined the winner of the auction.

Still referring to FIG. 4, process 400 is shown to include serving a third-party content item for presentation in conjunction with the published content based on a result of the auction (stage 414). Stage 414 may include selecting an eligible third-party content item based on a result of the auction. In some implementations, stage 414 includes selecting an eligible content item associated with the content provider that submits the highest bid. In some implementations, eligible content items include content items having characteristics matching the characteristics of the content slots in which the content items are to be presented. For example, stage 414 may include selecting a content item having a display size which fits in a destination content slot.

In some implementations, stage 414 includes selecting a third-party content item by comparing an expected return on investment associated with each of a set of eligible content items. For example, stage 414 may include comparing an established click-through-rate, a predicted click-through-rate, an estimated conversion rate, a relevancy rate, or other performance metrics associated with a plurality of potential content items (e.g., in order to maximize performance and/or value for the winning content provider). Stage 414 may include selecting an eligible third-party content item that satisfies the content distribution parameters of the winning content provider. In some implementations, stage 414 includes selecting a third-party content item that matches established user preferences for receiving individualized content. However, if an insufficient number of preferred content items are available, stage 414 may include selecting a content item that does not match established user preferences.

Stage 414 may include delivering the selected third-party content item to user devices 108 and/or first party resource 202 for presentation along with the published content. In some implementations, stage 414 includes resizing a selected content item to fit a content slot or add additional visual content to the selected content item (e.g., padding, a border, etc.) based on the display size of the content item and the display size of the content slot. Stage 414 may include determining whether additional third-party content items can be presented in the same content slot (e.g., based on the display size of the selected content item.) Stage 414 may include resizing, reshaping, or otherwise adjusting multiple third-party content items for concurrent presentation in a single content slot.

In some implementations, stage 414 includes interacting with the published content and/or user devices 108 to determine whether the selected third-party content item was successfully presented. Stage 414 may include receiving a notification of successful presentation and accounting for the served impression. Accounting for a served impression may include causing payment to a content provider responsible for the published content (e.g., a first-party content provider) and billing the winning third-party content provider for the opportunity to present a third-party content item.

Still referring to FIG. 4, process 400 is shown to include injecting another measurement object into the published content (stage 416). As shown, stage 416 may be performed concurrently or substantially concurrently with stage 408 (e.g., prior to auctioning the available impression). In various implementations, stage 416 may be performed at any time between the time at which the notification of the available impression is received (stage 406) and the time at which the published content finishes loading. In other words, stage 416 may be performed at any time the published content is loading (e.g., concurrently with stages 408-414). Stage 416 may be substantially the same or similar to stage 402.

Once injected, the measurement object may be executed or run by executing the code contained therein. In some implementations, the measurement object waits for the published content to filly load (stage 418) before performing an assessment of the visual clutter associated with the published content. Upon the published content fully loading, the measurement object may automatically measure one or more clutter attributes and calculate a clutter metric for the published content. The measurement object may report the clutter metric to RTB exchange 204.

Process 400 is shown to further include receiving and storing another clutter metric for the published content (stage 420). Stage 420 may be substantially the same or similar to stage 402. As shown, stages 416-418 can be performed concurrently with stages 408-414. Once the third-party content item has been served in stage 414 and the published content has finished loading, stage 420 can be performed. However, stages 416-420 are also asynchronous with stages 408-414. In other words, the clutter data gathered in stages 416-420 may not be available soon enough for use in stages 408-414 (e.g., because stage 420 may not be performed until after stage 414). Stages 408-414 may rely on clutter data previously gathered in stages 402-404 rather than the clutter data being concurrently-gathered in stages 416-420. Stages 406-420 may be repeated iteratively (each time a new notification of an available impression is received. Each iteration of stages 406-420 may gather new clutter data from the published content while using previously-gathered clutter data to auction the available impression to third-party content providers.

Referring now to FIG. 5, a drawing 500 of a content element is shown, according to a described implementation. Drawing 500 is shown to include a content element 502. In FIG. 5, content element 502 has a display size of 507 pixels by 170 pixels. The display size of content element 502 can be extracted from an attribute thereof. Drawing 502 is shown to further include padding 504, a border 506, and a margin 508 around content element 502. Padding 504 may be a number of pixels above, below, and/or to the sides of content elements 502. The size of padding 504 may be static or dynamic (e.g., based on the size of content element 502). Border 506 is shown surrounding padding 504 and margin 508 is shown surrounding border 506. The sizes of border 506 and margin 508 may also be static or dynamic.

Referring now to FIG. 6, a drawing 600 of a first-party resource with various content elements is shown, according to a described implementation. Drawing 600 is shown to include a third-party content element 602 and several other content elements 604, 606, 608, and 610. Each of content elements 602-610 is shown to include a centroid (i.e., centroids 610-620). For example, third-party content element 602 is shown to include centroid 612, content element 604 is shown to include centroid 614, content element 606 is shown to include centroid 616, content element 608 is shown to include centroid 618, and content element 610 is shown to include centroid 620. Centroids 612-620 may be the geometric centers of content elements 602-610. The coordinates of centroids 612-620 may be determined (e.g., by the injected measurement object) by extracting position coordinates (e.g., upper left, upper right, lower left, and lower right) for each of content elements 602-610.

Drawing 600 is shown to further include dotted lines 622, 624, 626, and 628 connecting centroid 610 with centroids 612, 614, 616, and 618 respectively. Dotted lines 622-628 represent the average distance between third-party content element 602 and content elements 604-610. As previously described with reference to FIGS. 1-4, the distances of dotted lines 622-628 may be used to calculate a density index metric for the first-party resource on which content elements 602-610 are displayed.

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate components or media (e.g., multiple CDs, disks, or other storage devices). Accordingly, the computer storage medium is both tangible and non-transitory.

The operations described in this disclosure may be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products embodied on one or more tangible media.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The construction and arrangement of the systems and methods as shown in the various illustrated implementations are examples only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions and arrangement of the exemplary implementations without departing from the scope of the present disclosure.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A method for identifying and exposing content element density and congestion, the method comprising:
receiving, at one or more processors, a notification of a first available impression for presenting a third-party content item on a client device in conjunction with published content;
retrieving, by the one or more processors, a clutter metric for the published content, wherein the clutter metric represents at least one of a content element density or a content element congestion of the published content;
using the clutter metric to select, by the one or more processors, a third-party content item for presentation on the client device in conjunction with the published content;
in response to receiving the notification of the first available impression, providing the selected third-party content item and a measurement object to the client device, wherein the measurement object runs on the client device and is configured to automatically measure a clutter attribute of the published content in response to a determination by the measurement object that the published content is fully loaded on the client device, wherein the clutter attribute represents at least one of a number of content elements of the published content displayed in conjunction with the third-party content item, a display size of the content elements, or a position of the content elements relative to the third-party content item, and wherein the measurement object is configured to generate an updated clutter metric for the published content based on the measured clutter attribute and to report the updated clutter metric from the client device to the one or more processors;
storing, by the one or more processors, the updated clutter metric; and
using the updated clutter metric reported by the measurement object provided in response to the notification of the first available impression to select, by the one or more processors, a second third-party content item for presentation in conjunction with the published content in response to a notification of a second available impression subsequent to the first available impression.

2. The method of claim 1, further comprising:
auctioning the available impression to the one or more third-party content providers;
selecting a winning bid received from the one or more third-party content providers as a result of the auction; and
serving the selected third-party content item for presentation in conjunction with the published content, the selected third-party content item corresponding to the winning bid.

3. The method of claim 2, further comprising:
automatically adjusting the winning bid based on the clutter metric.

4. The method of claim 1, wherein the measurement object is provided prior to the published content fully loading,
wherein the measurement object is configured to wait until the published content is fully loaded before measuring the clutter attribute of the published content.

5. The method of claim 1, further comprising:
serving the selected third-party content item for presentation in conjunction with the published content, wherein serving the selected third-party content item occurs prior to the measurement object measuring the clutter attribute.

6. The method of claim 1, further comprising:
serving the selected third-party content item for presentation in conjunction with the published content, wherein providing the measurement object occurs concurrently with serving the selected third-party content item.

7. The method of claim 1, wherein the clutter attribute of the published content comprises at least one of:
a size of an element on the published content for displaying third-party content items relative to other visual elements on the published content;
a distance between the element for displaying third-party content items and an adjacent visual element of the published content;
a number of visual elements on the published content; or
a density of visual elements on the published content.

8. The method of claim 1, wherein generating the clutter metric comprises parsing a document object model for the published content.

9. The method of claim 1, wherein the measurement object comprises computer-executable code injected into preexisting code of the published content.

10. The method of claim 1, wherein selecting the third-party content item comprises providing one or more third-party content providers with a quality score for the published content, the quality score comprising at least one of:
the clutter metric; or
an aggregate quality score for the published content, wherein the aggregate quality score is based on the clutter metric and one or more other factors.

11. The method of claim 1, further comprising:
determining a performance metric for a third-party content item, wherein the performance metric is a function of the clutter metric;
determining a pricing value for the third-party content item based on the performance metric; and
determining a target bid for the available impression based on the pricing value of the third-party content item.

12. A system for identifying and exposing content element density and congestion, the system comprising:
a processing system having one or more processors and memory, wherein the one or more processors are configured to receive a notification of a first available impression for presenting a third-party content item on a client device in conjunction with published content;
wherein the one or more processors are configured to retrieve a clutter metric for the published content, wherein the clutter metric represents at least one of a content element density or a content element congestion of the published content;
wherein the one or more processors are configured to use the clutter metric to select a third-party content item for presentation on the client device in conjunction with the published content;
wherein the one or more processors are configured to, in response to receiving the notification of the first available impression, provide the selected third-party content item and a measurement object to the client device, wherein the measurement object runs on the client device and is configured to automatically measure a clutter attribute of the published content in response to a determination by the measurement object that the published content is fully loaded on the client device, wherein the clutter attribute represents at least one of a number of content elements of the published content displayed in conjunction with the third-party content item, a display size of the content elements, or a position of the content elements relative to the third-party content item, and wherein the measurement object is configured to generate an updated clutter metric for the published content based on the measured clutter attribute and to report the updated clutter metric from the client device to the one or more processors;
wherein the one or more processors are configured to store the updated clutter metric; and
wherein the one or more processors are configured to use the updated clutter metric reported by the measurement object provided in response to the notification of the first available impression to select a second third-party content item for presentation in conjunction with the published content in response to a notification of a second available impression subsequent to the first available impression.

13. The system of claim 12, wherein the processing system is configured to:
auction the available impression to the one or more third-party content providers;
select a winning bid received from the one or more third-party content providers as a result of the auction; and
serve the selected third-party content item for presentation in conjunction with the published content, the selected third-party content item corresponding to the winning bid.

14. The system of claim 13, wherein the processing system is configured to:
automatically adjust the winning bid based on the clutter metric.

15. The system of claim 12, wherein the measurement object is provided prior to the published content fully loading,
wherein the measurement object is configured to wait until the published content is fully loaded before measuring the clutter attribute of the published content.

16. The system of claim 12, wherein the processing system is configured to:
serve the selected third-party content item for presentation in conjunction with the published content, wherein providing the measurement object occurs concurrently with serving the selected third-party content item.

17. The system of claim 12, wherein the clutter attribute of the published content comprises at least one of:
a size of an element on the published content for displaying third-party content items relative to other visual elements on the published content;
a distance between the element for displaying third-party content items and an adjacent visual element of the published content;
a number of visual elements on the published content; and
a density of visual elements on the published content.

18. The system of claim 12, wherein generating the clutter metric comprises parsing a document object model for the published content;
wherein the measurement object comprises computer-executable code injected into preexisting code of the published content.

19. The system of claim 12, wherein selecting the third-party content item comprises providing one or more third-party content providers with a quality score for the published content, the quality score comprising at least one of:
an aggregate quality score for the published content, wherein the aggregate quality score is based on the clutter metric and one or more other factors.

20. One or more non-transitory computer-readable storage media comprising instructions for identifying and exposing content element density and congestion, the instructions being executable by one or more processors to cause the one or more processors to perform operations comprising:
receiving a notification of a first available impression for presenting a third-party content item on a client device in conjunction with published content;
retrieving a clutter metric for the published content, wherein the clutter metric represents at least one of a content element density or a content element congestion of the published content;
using the clutter metric to select a third-party content item for presentation on the client device in conjunction with the published content;
in response to receiving the notification of the first available impression, providing the selected third-party content item and a measurement object to the client device, wherein the measurement object is configured to automatically measure a clutter attribute of the published content in response to a determination by the measurement object that the published content is fully loaded on the client device, wherein the clutter attribute represents at least one of a number of content elements of the published content displayed in conjunction with the third-party content item, a display size of the content elements, or a position of the content elements relative to the third-party content item, and wherein the measurement object is configured to generate an updated clutter metric for the published content based on the measured clutter attribute and to report the updated clutter metric from the client device to the one or more processors;
storing the updated clutter metric; and
using the updated clutter metric reported by the measurement object provided in response to the notification of the first available impression to select a second third-party content item for presentation in conjunction with the published content in response to a notification of a second available impression subsequent to the first available impression.
